(19) United States
(12) Patent Application Publication
(10) Pub. No.: US 2019/0317042 A1
(43) Pub. Date: Oct. 17, 2019

(54) SYSTEMS AND METHODS FOR A PRINTED ELECTROCHEMICAL GAS SENSOR

(71) Applicant: Honeywell International Inc., Morris Plains, NJ (US)

(72) Inventors: Qinghui Mu, Shanghai (CN); Ling Liu, Shanghai (CN); Feng Liang, Shanghai (CN)

(21) Appl. No.: 16/379,516

(22) Filed: Apr. 9, 2019

Related U.S. Application Data
(60) Provisional application No. 62/657,293, filed on Apr. 13, 2018.

(51) Int. Cl. G01N 27/407; H01M 4/88; H01M 4/86; H01M 4/92

(52) U.S. Cl. CPC G01N 27/4075; H01M 4/8807; H01M 4/926; H01M 4/8668; H01M 4/8882; H01M 4/8828

(57) ABSTRACT

Embodiments include systems and methods for manufacturing an electrochemical sensor. An electrochemical sensor may comprise a substrate; a plurality of electrodes printed over the substrate; a transition layer printed over the plurality of electrodes, the transition layer comprising at least a mixture of a water immiscible liquid and a hydrophilic inert substance; and a second layer comprising at least another mixture of an acid solution and a solid polymer printed over the transition layer and providing an electrolytic contact with the plurality of electrodes. A method of manufacturing an electrochemical sensor may comprise providing a plurality of electrodes over a substrate; printing a transition layer comprising at least a first mixture of a water immiscible liquid and a hydrophilic inert substance over the plurality of electrodes; and providing a second layer comprising at least a second mixture of an acid solution and a solid polymer over the transition layer.

### CROSS-REFERENCE TO RELATED APPLICATIONS

The present application claims priority to U.S. Provisional Patent Application Ser. No. 62/657,293 filed Apr. 13, 2018 by Qinghui Mu, et al. and entitled “Systems and Methods for a Printed Electrochemical Gas Sensor” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Electrochemical gas sensors are well known for detecting and quantifying toxic gases such as carbon monoxide, oxygen and the like. Such sensors can be implemented using electrochemical cells. Electrochemical sensors traditionally comprise a gas diffusion working (or sensing) electrode, often based on a platinum or graphite/platinum catalyst dispersed on polytetrafluorethylene (PTFE) tape. The target gas is reacted at this electrode while a balancing reaction takes place at the counter electrode. The electrodes are contained within an outer housing which contains a liquid electrolyte, such as sulfuric acid. The gas typically enters the housing through a controlled diffusion access port, which regulates the ingress of target gas into the cell. The gas reacts at the electrode and affects the electrical output of the sensor.

### SUMMARY

In an embodiment, an electrochemical gas sensor may comprise a substrate comprising diffusion holes through the substrate; a plurality of electrodes printed over the substrate, the plurality of electrodes covering at least one of the diffusion holes; a transition layer printed over the plurality of electrodes, the transition layer comprising at least a mixture of a water immiscible liquid and a hydrophilic inert substance; a electrolyte layer comprising at least another mixture of an acid solution and a solid polymer printed over the transition layer and providing an electrolytic contact with the plurality of electrodes; and a encapsulation layer comprising silicone printed over the electrolyte layer.

In an embodiment, a method of manufacturing an electrochemical sensor may comprise providing a plurality of electrodes over a substrate comprising diffusion holes, the plurality of electrodes covering the diffusion holes extending cylindrically along the thickness of the substrate; applying (e.g. printing) a transition layer comprising at least a first mixture of a water immiscible liquid and a hydrophilic inert substance over the plurality of electrodes; and providing a electrolyte layer comprising at least a second mixture of an acid solution and a solid polymer over the transition layer.

In an embodiment, a method of manufacturing an electrochemical sensor may comprise printing, in a vacuum, a slurry over a substrate to form a plurality of electrodes on the substrate, wherein the plurality of electrodes cover one or more diffusion holes through the substrate; printing a transition layer comprising a mixture of a water immiscible liquid and a hydrophilic inert substance over the plurality of electrodes; and providing an electrolyte layer comprising at least a second mixture of an acid solution and a solid polymer over the transition layer, wherein the electrolyte layer provides electrical contact between the plurality of electrodes.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a cross-sectional view of an electrochemical sensor according to an embodiment of the disclosure.

FIG. 2 illustrates a detailed cross-sectional view of an electrochemical sensor according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field (for example ±10%); and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods which may reduce electrolyte leakage within an electrochemical sensor and/or improve contact between the electrolyte and a plurality of electrodes. The electrodes may be formed on a substrate and may contact ambient gas via diffusion holes through the substrate. The electrodes in the sensor may participate in electrochemical reactions via contact with the electrolyte, and may also prevent electrolyte leaking from the diffusion holes. However, in some electrochemical sensors, the electrodes may not be robust enough to prevent electrolyte leakage through the diffusion holes, particularly during high humidity (e.g., more than 95% relative humidity (RH)). Meanwhile, the preparation of the catalyst paste for forming the electrode(s) may easily introduce moisture into the electrochemical sensor, which may have a negative effect on the printing process, and may lead to the electrodes connecting during the printing formation process (and may result in a short out within the sensor).

When traditionally printing (or otherwise applying) the electrolyte on the electrode(s), there may be a high rate of failure because the electrode comprises a hydrophobic material, while the electrolyte is hydrophilic. For effective functioning of the electrochemical sensor, the electrolyte must contact the electrode, and in some cases permeate and/or wet the electrode material.

Embodiments of the disclosure describe a process to prepare a homogenous catalyst paste for forming an electrode on a substrate which can remove and/or prevent moisture from pervading the electrode and may result in a robust electrode with resistance to leakage through the diffusion holes during high humidity (more than 95% RH). Some embodiments of the disclosure may comprise changing the concentration of the mixture of the perfluorinated ion solution and a catalyst (Pt, Au, Ru, Ir, Ag powder, carbon black, graphite, and/or a combination thereof) and solve the problem of leakage from the diffusion holes during high humidity.

Additionally, embodiments of the disclosure may include a transition layer applied between the electrode(s) and the electrolyte, where the transition layer may facilitate contact between the electrode(s) and the electrolyte. The transition layer may comprise a thin, hydrophilic material. In some embodiments, the transition layer may be applied to the electrode before the electrolyte is applied to the electrode.

In some embodiments, a perfluorinated ion solution (e.g., GEFC, 5 wt % in DMF, Golden Energy Fuel Cell Co., Ltd.) may be used as a binder in a catalyst paste which may be printed onto a substrate to form electrodes (e.g. through annealing). A method may comprise mixing the perfluorinated ion solution with a catalyst (e.g., Pt, Au, Ru, Ir, Ag powder, carbon black, graphite, and/or a combination thereof). Then, the mixture may be concentrated by heating to make a paste with a suitable viscosity for printing. The paste may be printed on to a substrate comprising diffusion holes to form electrodes through annealing. The diffusion holes may be formed into the substrate and may extend through the substrate thickness.

Typically, the mixing process and/or printing process may be performed in an open system where the mixture may be exposed to an ambient environment, which may allow moisture from the ambient air to penetrate the electrodes and/or other elements of the sensor during printing. In an embodiment of the disclosure, the mixing process and/or the printing process may be completed under a vacuum, to prevent moisture and/or other substances from the ambient environment from penetrating the materials of the layers of the electrochemical sensor.

In a method of the disclosure, concentrating of the perfluorinated ion solution and subsequent mixing with a catalyst may be combined into a single step. In some instances, these processes may be completed using ultrasonication to generate a slurry made of the perfluorinated ion solution and catalyst powder in a homogenous suspension. Additionally, the preparation may be performed by vacuum distillation in a relatively closed system with negative-pressure condition. In an embodiment, the process conditions may be approximately 2-3 mbar and approximately 40-50° C. The viscosity of the mixture may be controlled by monitoring the rotation speed of a magnetic stirrer.

The lower temperature (e.g., 40-50° C.) of the disclosed method may not cause undesirable binding of the perfluorinated ion solution. Additionally, the concentrating process may produce more interaction between the perfluorinated ion solution binder and the catalyst particles than traditional simple mixing of concentrated perfluorinated ion solution and catalyst powder, where the interaction contributes to the strength and robustness of the electrodes and may prevent electrolyte leakage in the final sensor.

Embodiments of the disclosure may also (or alternatively) comprise systems and methods to facilitate the printing of a hydrophilic electrolyte onto one or more hydrophobic electrodes. Such a method may comprise printing a transition layer onto the electrodes before printing an electrolyte. The transition layer may comprise a water-immiscible solvent and a hydrophilic, inert powder. The added transition layer may not significantly thicken the electrode(s), because the same stencil and/or template may be used during printing of the electrode and printing of the transition layer, and the printed hydrophilic particles of the transition layer may disperse or otherwise fit into holes and/or spaces created on the surface of the electrodes by the catalyst of the electrodes. In some embodiments, there may be substantially no change in the thickness of the electrode due to adding of the transition layer. With the transition layer in place on the surface of the electrode (opposite the substrate and/or direct towards the electrolyte), the surface of the electrodes may become more hydrophilic, and the electrolyte can be more easily printed onto the electrodes. The transition layer may be thin enough to not interfere with interaction between the electrodes and the electrolyte. In some embodiments, the transition layer may comprise conductive properties configured to allow for electric communication between the electrodes and the electrolyte.

Embodiments of the disclosure include a homogenous catalyst paste for a printed electrochemical gas sensor, such as a CO and/or H₂S sensor. Embodiments of the disclosure include methods of coating a hydrophilic electrolyte on a hydrophobic electrode for a printed electrochemical gas sensor.

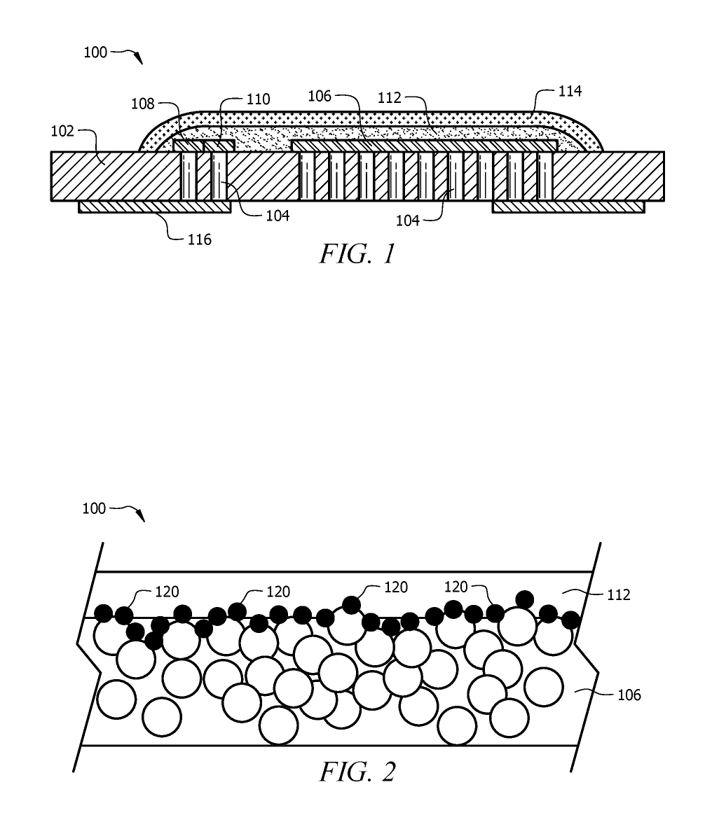

Referring to FIG. 1, an ultrathin electrochemical (EC) sensor 100 may be made by printing technology. The sensor 100 may comprise one or more electrodes 106, 108 and 110, an electrolyte 112 (wherein the electrolyte typically contacts and provides electrical interaction between all the electrodes), and/or an encapsulation layer 114, which may be printed layer by layer onto a substrate 102. The substrate 102 may comprise a plurality of diffusion holes 104, wherein the one or more electrodes 106, 108, and 110 may be printed over the diffusion holes 104 (for example, with each electrode having at least one diffusion hole underlying it). In some embodiments, the diffusion holes 104 may comprise a size, shape, a first diameter, a second diameter, and/or length that causes a capillary effect within the diffusion holes 104. The electrolyte 112 may be printed or otherwise applied over the electrodes 106, 108, and 110. The electrodes may comprise a sensing electrode 106, a reference electrode 108, and a counter electrode 110.

The encapsulation layer 114 can be used to seal the electrolyte 112 (e.g. creating an envelope applied to the substrates which seals the electrolyte and underlying electrodes). The encapsulation layer 114 can comprise any material suitable for bonding to the substrate 102 and retaining the electrolyte 112 in position on the substrate 102. In an embodiment, any of the materials described herein can be used for the encapsulation layer 114. Additional materials such as silicone rubber or other polymeric materials can also be used as the encapsulation layer 114. The encapsulation layer 114 may comprise a silicon or silicone material. Once disposed over the electrolyte 112 (e.g., a liquid electrolyte, a gelled electrolyte, and/or a solid electrolyte), the encapsulation layer 114 may serve as a water vapor diffusion barrier to seal the electrolyte 112 from the external environment. In some embodiments, the encapsulation layer 114 may be flexible to allow the volume of the electrolyte 112 to change over time, for example, in response to a gain or loss of water in a hygroscopic electrolyte.

A solution of perfluorinated ion electrolyte solution (GEFC-IES the copolymer of perfluorosulfonic acid and PTFE) commercially available from Golden Energy Fuel Cell Co., Ltd. or Nation® (copolymer of tetrafluoroethylene (Teflon®) and perfluoro-3,6-dioxa-4-methyl-7-octene-sulfonic acid) commercially available from Dupont™, can be used as a binder. The catalyst (as described above) may Pt, Au, Ru, Ir, Ag powder, carbon black, graphite, and/or a combination thereof. Glycol or other similar chemicals can be used as a diluent to form a catalyst slurry, recipe or catalyst system, which can be printed on a PTFE membrane by a printer. The printed element is sintered at an elevated temperature to form an electrode which can be used in an electrochemical sensor.

The sensing electrode 106, the reference electrode 108, and the counter electrode 110 can be arranged in a co-planar, non-overlapping arrangement on the surface of the substrate 102. While shown in FIG. 1 as having three electrodes, the sensor 100 can also be used with only two electrodes, for example including the sensing electrode 106 and the counter electrode 110. In some embodiments, four or more electrodes may also be present. For example, two or more sensing electrodes can be present and each sensing electrode may operate at a different potential to enable the detection of more than one target gas. Alternatively, four or more electrodes may be present to enable diagnostic tests to be conducted during operation of the sensor 100, continuously, periodically, or aperiodically. In some contexts, the sensing electrode 106 may also be referred to as a working electrode.

The composition, size, and configuration of the electrodes 106, 108, 110 can depend on the specific species of target gas or gasses being detected by the sensor 100. When semiconductor manufacturing techniques are used to form the sensor 100, the electrodes 106, 108, 110 may comprise materials capable of being deposited by such processes as thermal deposition, sputtering, chemical vapor deposition, etching, electrodeposition, or the like. For example, the electrodes 106, 108, 110 may comprise materials capable of being electrodeposited and etched to form the individual electrodes.

In some embodiments, one or more (or all) of the electrodes 106, 108, 110 can comprise a porous, gas permeable membrane. In this embodiment, the electrode (e.g., the sensing electrode 106), may be placed over the aperture or capillary (which may also be called a diffusion hole 104). The gas diffusing through the capillary 104 may then contact and diffuse through the permeable membrane to react with the electrolyte 112 at the opposite surface of the electrode. Such an electrode can be formed of any of the materials described herein. In addition to any of the materials for forming the electrode, various hydrophobic components such as PTFE can be combined with the electrode material and/or used as a backing layer (e.g., as a tape or support) for the electrode on the substrate 102. For example, sensing electrode 106 can comprise a catalyst such as platinum or carbon, supported on a PTFE membrane. In some embodiments, such as toxic gas sensors, the counter electrode 110 may comprise a catalyst mounted on a PTFE backing tape, in the same manner as the gas sensing electrode 106.

In some embodiments, the electrodes can comprise hydrophobic materials. Various coatings such as PTFE coatings can be used to provide a hydrophobic surface while maintaining a degree of porosity for gas diffusion of the target gas. In some embodiments, the electrode material can be formed to exhibit hydrophobicity or super-hydrophobicity. In an embodiment, the electrode material can be formed using a template material to form a patterned surface for the electrode, where the pattern may impart hydrophobic properties to the electrode. The patterning material can include any suitable material that can be removed once the electrode is formed. In an embodiment, nanosized polymer spheres (e.g., nanosized latex spheres-which are commercially available) can be arranged on a suitable sacrificial substrate (e.g., a metal such as copper). The electrode metal can then be electroplated around the assembled spheres to produce a suitable hydrophobic surface. The resulting electrode surface may also have porosity for gas diffusibility. Plating bath additives may be added as appropriate. Alternatively, other templating techniques such as self-assembled surfactant molecules can be used. The templating material can then be subsequently removed, for example by dissolution, heat, or the like. The resulting electrode material can then be used for one or more of the electrodes 106, 108, 110 while exhibiting hydrophobic properties. Electrodes may be formed using one or more of the methods/processes described herein.

The electrodes 106, 108, 110 may be at least partially covered by or in contact with the electrolyte 112 (and typically might all be entirely covered by the electrolyte. Electrical contact can be made with an external contact lead through one or more electrical conductors such as wires 116. The wires 116 can comprise foils, wires, or deposited materials on the substrate 102. The electrical conductors may comprise noble metals (e.g., platinum), such as by being formed from noble metals or coated with noble metals if the conductors are in contact with the electrolyte 112. In some embodiments, the electrical conductors may not be formed from noble metals if the electrical conductors are not in contact with the electrolyte 112.

The electrolyte 112 may comprise any material capable of providing an electrically conductive pathway between the electrodes 106, 108, 110. The electrolyte 112 may be non-reactive with the substrate 102 material. If the electrolyte 112 and the substrate 102 can react, an insulting, non-reactive layer may be placed over the substrate prior to disposition of the electrodes 106, 108, 110 and the electrolyte 112. The electrolyte 112 can comprise a liquid electrolyte, a gelled electrolyte, a solid electrolyte, or the like. In some embodiments, the electrolyte 112 can be contained in or retained by a porous or absorbent material.

In an embodiment, the electrolyte 112 can comprise any aqueous electrolyte such as a solution of a salt, an acid, and/or a base depending on the target gas of interest. In an embodiment, the electrolyte can comprise a hygroscopic acid such as sulfuric acid for use in an oxygen sensor. For example, the electrolyte can comprise sulfuric acid having a molar concentration between about 3 M to about 10 M. Since sulfuric acid is hygroscopic, the concentration can vary from about 10 to about 70 wt % (1 to 11.5 molar) over a relative humidity (RH) range of the environment of about 3 to about 95%. As another example, the electrolyte can include a lithium chloride salt having about 30% to about 60% Li Cl by weight, with the balance being an aqueous solution. Other target gases may use the same or different electrolyte compositions.

In addition to aqueous based electrolytes, ionic liquid electrolytes can also be used to detect certain gases. The ionic liquids may have a greater viscosity than a corresponding aqueous electrolyte. In any of the electrolytes, a viscosifier may be added to provide an increased viscosity, which may aid in retaining the electrolyte in contact with the electrolytes. In some embodiments, the electrolyte can be present in the form of a gel or a semi-solid.

In an embodiment, the electrolyte 112 can comprise a solid electrolyte. Solid electrolytes can include electrolytes adsorbed or absorbed into a solid structure such as a solid porous material and/or materials that allow protonic and or electronic conduction as formed. In an embodiment, the solid electrolyte can be a protonic conductive electrolyte membrane. The solid electrolyte can be a perfluorinated ion-exchange polymer such as Nafion or a protonic conductive polymer such as poly(ethylene glycol), poly(ethylene oxide), poly(propylene carbonate). Nafion is a hydrated copolymer of polytretafluoroethylene and polysulfonyl fluoride vinyl ether containing pendant sulfuric acid groups. When used, a Nafion membrane can optionally be treated with an acid such as H3PQ4, sulfuric acid, or the like, which improves the moisture retention characteristics of Nafion and the conductivity of hydrogen ions through the Nafion membrane. The sensing, counter and reference electrodes can be hot-pressed onto the Nafion membrane to provide a high conductivity between the electrodes and the solid electrolyte. The electrolyte 112 can be disposed on the substrate 102 as a drop or in a solid form so that the electrolyte is in electrical contact with the electrodes 106, 108, 110.

As shown in FIG. 2, the electrochemical sensor 100 may also comprise a transition layer 120 positioned between the hydrophobic electrode(s) 106 (which may be similar to those described in FIG. 1) and the electrolyte 112. In some embodiments, an electrode 106, 108 and/or 110 formed using a method as described herein may comprise increased hydrophobic characteristics when compared to traditional electrodes. In this case, the possibility of issues when applying the electrolyte to the electrode(s) may be increased as well. Therefore, a transition layer 120 may be applied between the electrode(s) and electrolyte to allow contact between the two.

In FIG. 2, the sensing electrode 106 is shown, but the transition layer 120 may be applied to any or all of the electrodes 106, 108, and 110 (e.g. of FIG. 1). The transition layer 120 may facilitate contact between the electrode(s) 106 and the electrolyte 112. The transition layer 120 may comprise a thin, hydrophilic material. In some embodiments, the transition layer 120 may be applied to the electrode 106 before the electrolyte 112 is applied to the electrode 106.

The transition layer 120 may comprise a water-immiscible solvent and a hydrophilic, inert powder. As an example, the transition layer 120 may comprise a perfluorinated ion solution and an inert silicon dioxide (SiO₂) powder. As shown in FIG. 2, the hydrophilic particles of the transition layer 120 may dispense into spaces fabricated by the catalyst of the electrode(s) 106, wherein the electrode(s) 106 may comprise approximately spherical material in the example shown in FIG. 2. With the transition layer 120, a top surface of the electrode(s) 106 may become more hydrophilic, and the electrolyte 112 can be more easily printed onto (e.g. atop) the electrode(s) 106 (e.g. on the surface opposite that contacting the substrate). The transition layer 120 may be thin enough to not interfere with interaction between the electrode(s) 106 and the electrolyte 112.

Some embodiments of the disclosure may comprise a method of forming a material that is used to form one or more electrodes and/or a method of forming an electrode. A method may comprise mixing approximately 19 grams (g) of perfluorinated ion solution (e.g., 5 wt % GEFC) and approximately 5 g of catalyst (e.g. one of the catalyst materials described above) to obtain a slurry. The slurry may be treated with ultrasonication for approximately 10-15 minutes, where the slurry may be mixed under vacuum distillation. During the mixing, the temperature may be controlled to be approximately 50° C., and the pressure may be approximately 2-3 mbar. In some embodiments, the temperature may controlled to be less than approximately 100° C. In some embodiments, the temperature may controlled to be between approximately 30° C. and 70° C. At the beginning of the mixing, the rotation speed of a magnetic stirrer may be set to approximately 500 rpm. As the mixture thickness, the rotation speed may decrease due to the increased thickness. When the rotation speed of the magnetic stirrer has decreased to approximately 300 rpm, mixing and distillation may be stopped, producing a paste. The paste may be printed onto a substrate to form the electrode(s). In some embodiments, a stencil may be placed onto and/or above the substrate, and the paste may be applied over the stencil to form the electrode(s). In some embodiments, the paste may be applied under a vacuum (as described above). In some embodiments, the paste may be applied over at least one diffusion hold that extends through the substrate.

Some embodiments of the disclosure may comprise a method of forming the transition layer. The method may comprise mixing approximately 4 g of perfluorinated ion solution (15 wt % GEFC) and approximately 4 g of inert SiO2 powder (e.g., AEROSIL® 200). In other words, the mixture may comprise 1 part perfluorinated ion solution to 1 part inert powder. After mixing, the mixture may be rested until bubbles disappear. Then, the mixture may be printed to form the transition layer with the same stencil as that used in printing the electrode onto the substrate. In some embodiments, the transition layer may be heated at approximately 40-50° C. for approximately 10 to 15 minutes. The heating temperature and time may be determined to maintain the hydrophilicity of the transition layer. Then, the electrolyte may be applied (e.g., printed) onto the electrode(s) comprising the transition layer. This method of forming a transition layer may also be used on electrodes formed using the above method of forming electrodes.

Having described some systems and methods herein, various embodiments can include, but are not limited to:

In a first embodiment, an electrochemical gas sensor may comprise a substrate comprising diffusion holes through the substrate; a plurality of electrodes printed over the substrate, the plurality of electrodes covering at least one of the diffusion holes; a transition layer printed over the plurality of electrodes, the transition layer comprising at least a mixture of a water immiscible liquid and a hydrophilic inert substance; a electrolyte layer comprising at least another mixture of an acid solution and a solid polymer printed over the transition layer and providing an electrolytic contact with the plurality of electrodes; and a encapsulation layer comprising silicone printed over the electrolyte layer.

A second embodiment can include the electrochemical gas sensor of the first embodiment, wherein the substrate comprises one or more of ceramic, silicon, glass, plastic, or printed circuit board.

A third embodiment can include the electrochemical gas sensor of the first or second embodiment, wherein the plurality of electrodes printed over the substrate comprises a slurry printed over the substrate, and wherein the slurry comprises at least a binder and a catalyst.

A fourth embodiment can include the electrochemical gas sensor of the third embodiment, wherein the catalyst comprises at least one of platinum, platinum black, a noble metal, carbon black, and graphite, and wherein the binder comprises at least one of GEFC perfluorinated ion solution or Nafion® perfluorinated solution.

A fifth embodiment can include the electrochemical gas sensor of the third or fourth embodiment, wherein the slurry is treated with ultrasonication for a predetermined time-period.

A sixth embodiment can include the electrochemical gas sensor of any of the third through fifth embodiments, wherein the slurry is distilled in a vacuum at a predetermined temperature and at a predetermined pressure.

A seventh embodiment can include the electrochemical gas sensor of any of the first through sixth embodiments, wherein each of the diffusion holes are characterized by a first diameter, a second diameter opposite to the first diameter, and a depth through the substrate.

An eighth embodiment can include the electrochemical gas sensor of any of the first through seventh embodiments, wherein the second diameter is at most ten percent of the depth.

A ninth embodiment can include the electrochemical gas sensor of any of the first through seventh embodiments, wherein the water immiscible liquid comprises a perfluorinated ion solution, and wherein the hydrophilic inert substance comprises silicon dioxide.

A tenth embodiment can include the electrochemical gas sensor of any of the first through ninth embodiments, wherein the acid solution comprises one or more of sulfuric acid or phosphoric acid, and wherein the solid polymer comprises Polyvinylpyrrolidone (PVP) polymer.

In an eleventh embodiment, a method of manufacturing an electrochemical sensor may comprise providing a plurality of electrodes over a substrate comprising diffusion holes, the plurality of electrodes covering the diffusion holes extending cylindrically along the thickness of the substrate; applying (e.g. printing) a transition layer comprising at least a first mixture of a water immiscible liquid and a hydrophilic inert substance over the plurality of electrodes; and providing a electrolyte layer comprising at least a second mixture of an acid solution and a solid polymer over the transition layer.

A twelfth embodiment can include the method of the eleventh embodiment, further comprising printing a encapsulation layer comprising silicone over the electrolyte layer.

A thirteenth embodiment can include the method of the eleventh or twelfth embodiment, wherein the water immiscible liquid is at least one of GEFC perfluorinated ion solution or Nafion® perfluorinated solution, and wherein the hydrophilic inert substance is silicon dioxide.

A fourteenth embodiment can include the method of any of the eleventh through thirteenth embodiments, wherein the acid solution comprises one or more of sulfuric acid or phosphoric acid, and wherein the solid polymer comprises Polyvinylpyrrolidone (PVP) polymer.

A fifteenth embodiment can include the method of any of the eleventh through fourteenth embodiments, wherein the first mixture is heated at a predetermined temperature for a predetermined time-period.

A sixteenth embodiment can include the method of any of the eleventh through fourteenth embodiments, wherein printing the plurality of electrodes further comprises printing a slurry over the substrate.

A seventeenth embodiment can include the method of the sixteenth embodiment, wherein printing the plurality of electrodes further comprises printing the slurry over the substrate in a vacuum.

An eighteenth embodiment can include the method of the sixteenth or seventeenth embodiment, wherein the slurry comprises at least a binder and a catalyst.

A nineteenth embodiment can include the method of the eighteenth embodiment, wherein the catalyst comprises at least one or more of platinum, platinum black, a noble metal, carbon black, or graphite, and wherein the binder comprises at least one of GEFC perfluorinated ion solution or Nafion® perfluorinated solution.

In a twentieth embodiment, a method of manufacturing an electrochemical sensor may comprise printing, in a vacuum, a slurry over a substrate to form a plurality of electrodes on the substrate, wherein the plurality of electrodes cover one or more diffusion holes through the substrate; printing a transition layer comprising a first of a water immiscible liquid and a hydrophilic inert substance over the plurality of electrodes; and providing an electrolyte layer comprising at least a second mixture of an acid solution and a solid polymer over the transition layer, wherein the electrolyte layer provides electrical contact between the plurality of electrodes.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. An electrochemical gas sensor comprising:
a substrate comprising diffusion holes through the substrate;
a plurality of electrodes printed over the substrate, the plurality of electrodes covering at least one of the diffusion holes;
a transition layer printed over the plurality of electrodes, the transition layer comprising at least a mixture of a water immiscible liquid and a hydrophilic inert substance;
an electrolyte layer comprising at least another mixture of an acid solution and a solid polymer printed over the transition layer and providing an electrolytic contact with the plurality of electrodes; and
an encapsulation layer comprising silicone printed over the electrolyte layer.

2. The electrochemical gas sensor of claim 1, wherein the substrate comprises one or more of ceramic, silicon, glass, plastic, and printed circuit board.

3. The electrochemical gas sensor of claim 1, wherein the plurality of electrodes printed over the substrate comprises a slurry printed over the substrate, and wherein the slurry comprises at least a binder and a catalyst.

4. The electrochemical gas sensor of claim 3, wherein the catalyst comprises at least one of platinum, platinum black, a noble metal, carbon black, and graphite, and wherein the binder comprises at least one of GEFC perfluorinated ion solution and Nafion® perfluorinated solution.

5. The electrochemical gas sensor of claim 3, wherein the slurry is treated with ultrasonication for a predetermined time-period.

6. The electrochemical gas sensor of claim 3, wherein the slurry is distilled in a vacuum at a predetermined temperature and at a predetermined pressure.

7. The electrochemical gas sensor of claim 1, wherein each of the diffusion holes are characterized by a first diameter, a second diameter opposite to the first diameter, and a depth through the substrate.

8. The electrochemical gas sensor of claim 7, wherein the second diameter is at most ten percent of the depth.

9. The electrochemical gas sensor of claim 1, wherein the water immiscible liquid comprises a perfluorinated ion solution, and wherein the hydrophilic inert substance comprises silicon dioxide.

10. The electrochemical gas sensor of claim 1, wherein the acid solution comprises one or more of sulfuric acid or phosphoric acid, and wherein the solid polymer comprises Polyvinylpyrrolidone (PVP) polymer.

11. A method of manufacturing an electrochemical sensor, the method comprising:
providing a plurality of electrodes over a substrate comprising diffusion holes, the plurality of electrodes covering the diffusion holes extending cylindrically through the thickness of the substrate;
applying a transition layer comprising at least a first mixture of a water immiscible liquid and a hydrophilic inert substance over the plurality of electrodes; and
applying an electrolyte layer comprising at least a second mixture of an acid solution and a solid polymer over the transition layer.

12. The method of claim 11, further comprising applying an encapsulation layer comprising silicone over the electrolyte layer.

13. The method of claim 11, wherein the water immiscible liquid is at least one of GEFC perfluorinated ion solution and Nafion® perfluorinated solution, and wherein the hydrophilic inert substance is silicon dioxide.

14. The method of claim 11, wherein the acid solution comprises one or more of sulfuric acid and phosphoric acid, and wherein the solid polymer comprises Polyvinylpyrrolidone (PVP) polymer.

15. The method of claim 11, wherein the first mixture is heated at a predetermined temperature for a predetermined time-period.

16. The method of claim 11, wherein providing the plurality of electrodes further comprises printing a slurry over the substrate.

17. The method of claim 16, wherein providing the plurality of electrodes further comprises printing the slurry over the substrate in a vacuum.

18. The method of claim 16, wherein the slurry comprises at least a binder and a catalyst.

19. The method of claim 18, wherein the catalyst comprises at least one or more of platinum, platinum black, a noble metal, carbon black, and graphite, and wherein the binder comprises at least one of GEFC perfluorinated ion solution and Nafion® perfluorinated solution.

20. A method of manufacturing an electrochemical sensor, the method comprising:
printing, in a vacuum, a slurry over a substrate to form a plurality of electrodes on the substrate, wherein the plurality of electrodes cover one or more diffusion holes through the substrate;
printing a transition layer comprising a mixture of a water immiscible liquid and a hydrophilic inert substance over the plurality of electrodes; and
providing an electrolyte layer comprising at least a second mixture of an acid solution and a solid polymer over the transition layer, wherein the electrolyte layer provides electrical contact between the plurality of electrodes.
